(19) United States
(12) Patent Application Publication
(10) Pub. No.: US 2021/0168284 A1
(43) Pub. Date: Jun. 3, 2021

(54) CAMERA SYSTEM FOR ENABLING SPHERICAL IMAGING

(71) Applicant: SKYDOME AB, Sollentuna (SE)

(72) Inventors: Peder SJÖLUND, Obbola (SE); Kim CAVALLIN, Järfälla (SE)

(73) Assignee: SKYDOME AB, Sollentuna (SE)

(21) Appl. No.: 17/042,017

(22) PCT Filed: Mar. 29, 2018
(86) PCT No.: PCT/SE2018/050340

§ 371 Date: Sep. 25, 2020

(51) Int. Cl. H04N 5/232; H04N 5/247; G03B 37/04; G02B 6/08; H04N 13/243

(52) U.S. Cl. CPC H04N 5/23238; H04N 5/247; H04N 13/243; G02B 6/08; G03B 37/04

(57) ABSTRACT

A camera system is provided comprising multiple camera sub-modules. Each camera sub-module comprises a tapered Fiber Optic Plate, FOP, which in tapered form is referred to as a Fiber Optic Taper, FOT, for conveying photons from an input surface to an output surface (of the FOT, each FOT comprising a bundle of optical fibers arranged together to form the FOT; and a sensor for capturing the photons of the output surface of the FOT and converting the photons into electrical signals, wherein the sensor is provided with a plurality of pixels, and each optical fiber of the FOT is matched to a set of one or more pixels on the sensor. The camera sub-modules are spatially arranged such that the input surfaces of the FOTs of the camera sub-modules together define an outward facing overall surface area, which generally corresponds to the surface area of a spheroid or a truncated segment thereof, for covering at least parts of a surrounding environment.

### TECHNICAL FIELD

The invention generally relates to a camera system comprising multiple camera sub-modules, as well as a camera sub-module.

### BACKGROUND

Spherical imaging typically involves a set of image sensors and wide-angle camera objectives spatially arranged to capture parts or the full spherical ambient field, each camera sub-system facing specific parts of the ambient and surrounding environment. Typical designs consist of 2 to 6 or more individually camera modules with wide angle optics creating a certain degree of image overlap between neighboring camera systems ensuring each of the individual images to be merged by image/video stitching algorithms. This, forming a stitched spherical video imagery. Image and video stitching is a well-known procedure to digitally merge individually images. Digital image stitching algorithms specifically designed for 360 images and videos consists in many forms and brands and are provided by many companies and commercial available software's.

Due to the spatial separation of each individual camera objective, as indicated in FIG. 1, each camera sees an object from a slightly different viewpoint causing parallax.

As illustrated in FIG. 1, two cameras A and B, are spatially displaced by the minimum amount caused by the physical size of the cameras and arranged to ensure certain degree of overlap of the cameras field of view. The spatial displacement between the cameras introduces parallax on the background in both scenes; left (both cameras are looking at the object) and right (both cameras are looking at the background). In both scenes, duplets of the objects are shown caused by the parallax between the two cameras where the amount of parallax is directly proportional to the translational displacement between the cameras and their optical entrance pupil position.

In the stitching process when two images merges, the image overlap area is associated with a parallax error where objects and background do not spatially overlap in the overlap area causing the merged image to display errors, see FIG. 2 for example.

A zero parallax would require the cameras to be physically merged in the same position in space. In FIG. 3, an illustrative image shows how parallax is removed when two cameras are merged and their respectively entrance pupils are set in the same physical point in space which by known camera, optical design and electrooptical methods prevents.

The image/video stitching algorithms demands high computer power processes and scales exponentially with increased image resolution and requires heavy CPU and GPU loads in real time processing.

Zero parallax may be one of the design requirements for a high performance, low CPU/GPU loads and ultra-low real time video processing and performance for spherical imaging camera. There may also be other requirements that need to be considered when building complex high-performance spherical imaging camera systems in an efficient manner.

### SUMMARY

It is a general object to provide an improved camera system for enabling spherical imaging.

It is a specific object to provide a camera system comprising multiple camera sub-modules.

It is another object to provide a camera sub-module for such a camera system. These and other objects are met by embodiments as defined herein.

According to a first aspect, there is provided a camera system comprising multiple camera sub-modules, wherein each camera sub-module comprises:
a tapered Fiber Optic Plate, FOP, which in tapered form is referred to as a Fiber Optic Taper, FOT, for conveying photons from an input surface to an output surface of the FOT, each FOT comprising a bundle of optical fibers arranged together to form the FOT;
a sensor for capturing the photons of the output surface of the FOT and converting the photons into electrical signals, wherein the sensor is provided with a plurality of pixels, and each optical fiber of the FOT is matched to a set of one or more pixels on the sensor,
wherein the camera sub-modules are spatially arranged such that the input surfaces of the FOTs of the camera sub-modules together define an outward facing overall surface area, which generally corresponds to the surface area of a spheroid or a truncated segment thereof, for covering at least parts of a surrounding environment.

In this way, an improved camera system is obtained. The proposed technology more specifically enables complex, high-performance and/or zero-parallax 2D and/or 3D camera systems to be built in an efficient manner.

For example, the camera sub-modules may be spatially arranged such that the output surfaces of the FOTs of the camera sub-modules are directed inwards towards a central part of the camera system, and the sensors are located in the central part of the camera system.

The camera system may thus be adapted, e.g., for immersive and/or spherical 360 degrees monoscopic and/or stereoscopic video content production for virtual, augmented and/or mixed reality applications.

The camera system may also be adapted, e.g., for volumetric capturing and light-field immersive and/or spherical 360 degrees video content production for virtual, augmented and/or mixed reality applications, including Virtual Reality (VR) and/or Augmented Reality (AR) applications.

By way of example, the FOTs may be adapted for conveying photons in the infrared, visible and/or ultraviolet part of the electromagnetic spectrum, and the sensor may be adapted for infrared imaging, visible light imaging and/or ultraviolet imaging.

According to a second aspect, there is provided a camera sub-module for a camera system comprising multiple camera sub-modules, wherein the camera sub-module comprises:
a tapered Fiber Optic Plate, FOP, which in tapered form is referred to as a Fiber Optic Taper, FOT, for conveying photons from an input surface to an output surface of the FOT, each FOT comprising a bundle of optical fibers arranged together to form the FOT;
a sensor for capturing the photons of the output surface of the FOT and converting the photons into electrical signals, wherein the sensor is provided with a plurality of pixels, and each optical fiber of the FOT is matched to a set of one or more pixels on the sensor.

Other advantages offered by the invention will be appreciated when reading the below description of embodiments of the invention.

### BRIEF DESCRIPTION OF THE DRAWINGS

The invention, together with further objects and advantages thereof, may best be understood by making reference to the following description taken together with the accompanying drawings, in which:

FIG. 1 is a schematic diagram illustrating an example of optical parallax introduced by two spatially separated cameras with overlapped field of view.

FIG. 2 is a schematic diagram illustrating an example of optical parallax introduced by two spatially separated cameras with overlapped field of view and corresponding image showing example of resulted stitched images corrected for pencil and background respectively.

FIG. 3 is a schematic diagram illustrating an example of zero introduced optical parallax when two cameras are positioned on top of each other with coincident optical entrance pupils allowing each camera the same view point in space causing zero parallax, however with a slight parallax in the vertical direction.

FIG. 4A is a schematic diagram illustrating an example of a FOP for conveying an image incident on its input surface to its output surface.

FIG. 4B is a schematic diagram illustrating an example of a typical manufactured FOT.

FIG. 5 is a schematic diagram illustrating example of a camera sub-module according to an embodiment, by which a modular camera system can be built.

FIG. 6 is a schematic diagram illustrating an example of a camera system built as a truncated icosahedron (a) composed of a plurality of pentagonal (b) shaped FOTs and hexagonal (c) shaped FOTs according to an illustrative embodiment.

FIG. 7 is a schematic diagram illustrating an example of a camera system comprising multiple camera sub-modules for connection to signal and/or data processing circuitry according to an illustrative embodiment.

FIG. 8 is a schematic diagram illustrating another example of a camera system comprising multiple camera sub-modules for connection to signal and/or data processing circuitry according to an illustrative embodiment.

FIG. 9 is a schematic diagram illustrating an example of a FOT comprising bundles of optical fibers, e.g. with ISA (Interstitial Absorption Method) and/or EMA (Extramural Absorption Method) methods applied in the manufacturing process according to an illustrative embodiment.

FIG. 10 is a schematic diagram illustrating an example of relevant parts of a sensor pixel array with two optical fibers of different sizes interfacing the pixel array; one optical fiber in size covering only one pixel and a larger optical fiber covering many pixels in the array according to an illustrative embodiment.

FIG. 11 is a schematic diagram illustrating an example of the outward facing surface pixel area of a camera sub-module according to an illustrative embodiment.

FIG. 12A is a schematic diagram illustrating an example of how the outward facing surface areas of two camera sub-modules define a joint outward facing surface area covering parts of a surrounding environment according to an illustrative embodiment.

FIG. 12B is a schematic diagram illustrating another example of how the outward facing surface areas of two camera sub-modules define an outward facing surface area covering parts of a surrounding environment according to an illustrative embodiment.

FIG. 13 is a schematic diagram illustrating an example of two hexagonal camera sub-modules define a joint outward facing surface pixel area covering parts of a surrounding environment according to an illustrative embodiment.

FIG. 14 is a schematic diagram illustrating an example of camera system built as a truncated icosahedron composed of a number of pentagonal and hexagonal shaped sub-modules, cut in half to show also the inner structure of such a camera system arrangement according to an illustrative embodiment.

FIG. 15 is a schematic diagram illustrating the outward facing surface area of a spherical camera system mapped into arbitrarily sized segments of External Virtual Pixel Elements, EVPE:s, according to an illustrative embodiment.

FIG. 16 is a schematic diagram illustrating examples of two types of wearable VR and AR, non-see-through and see-through devices, respectively according to an illustrative embodiment.

FIGS. 17A-B are schematic diagrams illustrating examples of a camera system in a 2D and 3D data readout configuration, respectively, intended for monoscopic 2D and stereoscopic 3D according to an illustrative embodiment.

FIG. 18 is a schematic diagram illustrating an example of a computer-implementation according to an embodiment.

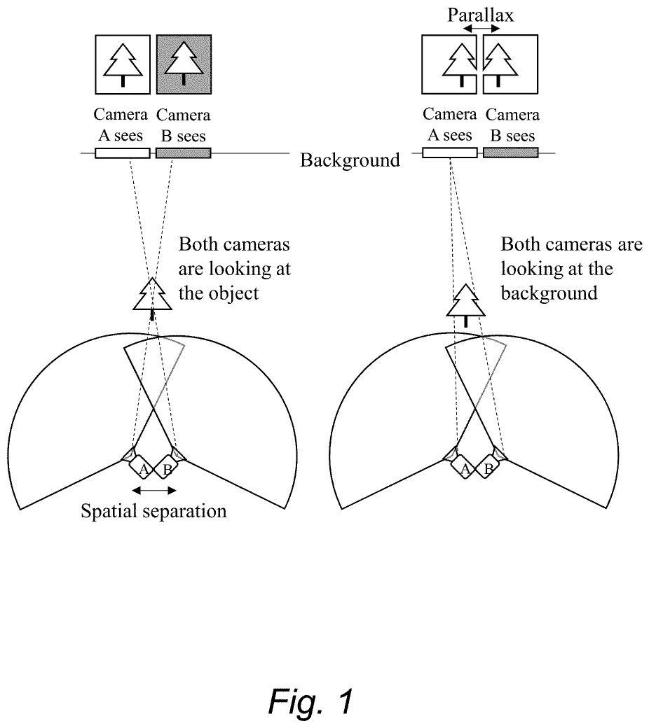

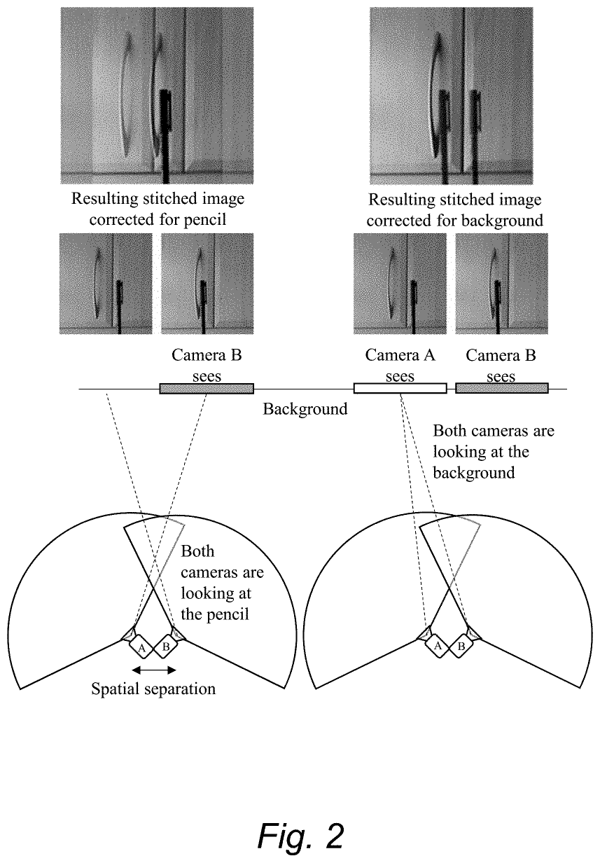

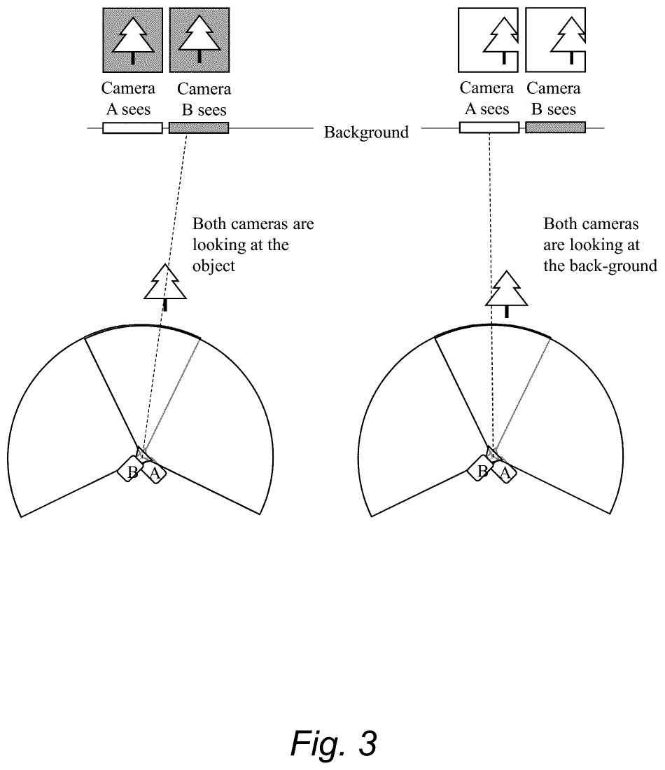

### DETAILED DESCRIPTION

Throughout the drawings, the same reference numbers are used for similar or corresponding elements.

On a general level, the proposed technology involves the basic key features followed by some optional features:

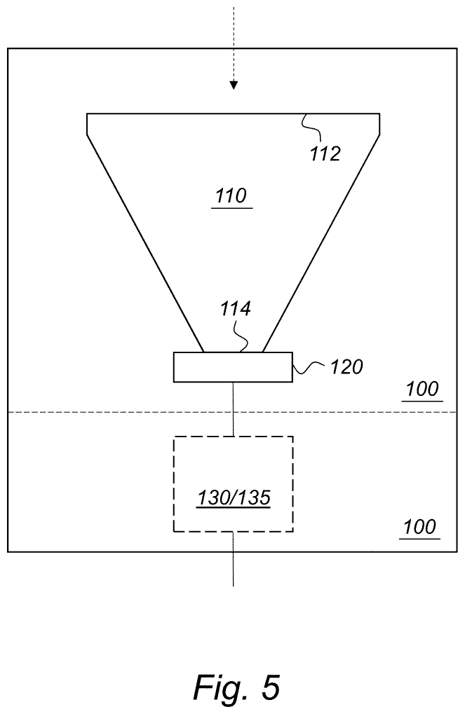

Reference can now be made to the non-limiting examples of FIGS. 5 to 18, which are schematic diagram illustrating different aspects and/or embodiments of the proposed technology.

According to a first aspect, there is provided a camera system 10 comprising multiple camera sub-modules 100, wherein each camera sub-module 100 comprises:
a tapered Fiber Optic Plate, FOP, which in tapered form is referred to as a Fiber Optic Taper, FOT, 110 for conveying photons from an input surface 112 to an output surface 114 of the FOT, each FOT comprising a bundle of optical fibers 116 arranged together to form the FOT;
a sensor 120 for capturing the photons of the output surface 114 of the FOT 110 and converting the photons into electrical signals, wherein the sensor 120 is provided with a plurality of pixels 122, and each optical fiber 116 of the FOT 110 is matched to a set of one or more pixels on the sensor,
wherein the camera sub-modules 100 are spatially arranged such that the input surfaces 112 of the FOTs 110 of the camera sub-modules 100 together define an outward facing overall surface area 20, which generally corresponds to the surface area of a spheroid or a truncated segment thereof, for covering at least parts of a surrounding environment

In this way, an improved camera system is obtained. The proposed technology more specifically enables complex, high-performance and/or zero-parallax camera systems to be built in an efficient manner.

It should be understood that the expression spherical imaging should be interpreted in a general manner, including imaging by a camera system that has an overall input surface, which generally corresponds to the surface area of a spheroid or a truncated segment thereof.

By way of example, the camera sub-modules may be spatially arranged such that the input surfaces 112 of the FOTs 110 of the camera sub-modules 100 together define an outward facing overall surface area 20, which generally corresponds to the surface area of a sphere or a truncated segment thereof to provide at least partially spherical coverage of the surrounding environment.

For example, the camera sub-modules may be spatially arranged such that the input surfaces 112 of the FOTs 110 of the camera sub-modules 100 together define an outward facing overall surface area 20, with half-spherical to full-spherical coverage of the surrounding environment.

FIG. 5 is a schematic diagram illustrating example of a camera sub-module according to an embodiment, by which a modular camera system can be built.

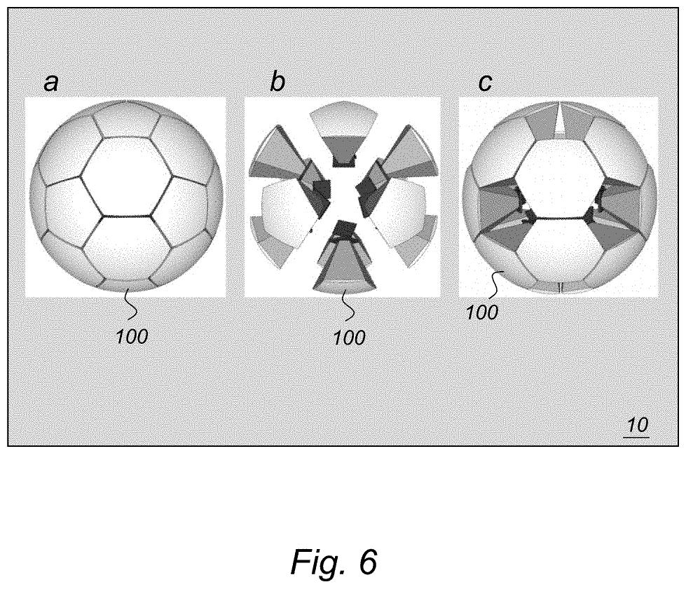

A number of non-limiting examples, where the camera sub-modules are spatially arranged such that the input surfaces of the FOTs of the camera sub-modules together define an outward facing overall surface area, which generally corresponds to the surface area of a spheroid or a truncated segment thereof, are illustrated in FIG. 6 and FIGS. 12 to 14.

For example, the camera sub-modules may be spatially arranged such that the output surfaces of the FOTs of the camera sub-modules are directed inwards towards a central part of the camera system, and the sensors are located in the central part of the camera system, e.g. see FIG. 6 and FIGS. 12 to 14.

In other words, the FOTs of the camera sub-modules may be spatially arranged to form a generally spherical three-dimensional geometric form or a truncated segment thereof having an outward facing overall surface area corresponding to the input surfaces of the FOTs.

In a particular set of examples, the FOTs of the camera sub-modules may be spatially arranged to form an at least partly symmetric, semi-regular convex polyhedron composed of two or more types of regular polygons, or a truncated segment thereof.

By way of example, the FOTs of the camera sub-modules may be spatially arranged to form a three-dimensional Archimedean solid or a dual or complementary form of an Archimedean solid, or a truncated segment thereof, and the input surfaces of the FOTs correspond to the facets of the Archimedean solid or of the dual or complementary form of the Archimedean solid, or a truncated segment thereof.

In the following, a set of non-limiting examples of geometric forms are given. For example, the FOTs of the camera sub-modules may be spatially arranged to form any of the following three-dimensional geometric forms, or a truncated segment thereof: cuboctahedron, great rhombicosidodecahedron, great rhombicuboctahedron, icosidodecahedron, small rhombicosidodecahedron, small rhombicuboctahedron, snub cube, snub dodecahedron, truncated cube, truncated dodecahedron, truncated icosahedron, truncated octahedron, and truncated tetrahedron, deltoidal hexecontahedron, deltoidal icositetrahedron, disdyakis dodechedron, disdyakis tracontahedron, pentagonal hexecontahedron, pentagonal icositetrahedron, pentakis dodecahedron, rhombic dodecahedron, rhombic tracontahedron, small triakis octahedron, tetrakis hexahedron, triakis icosahedron.

FIG. 6 is a schematic diagram illustrating an example of a camera system built as a truncated icosahedron (a) composed of a plurality of pentagonal (b) shaped FOTs and hexagonal (c) shaped FOTs according to an illustrative embodiment.

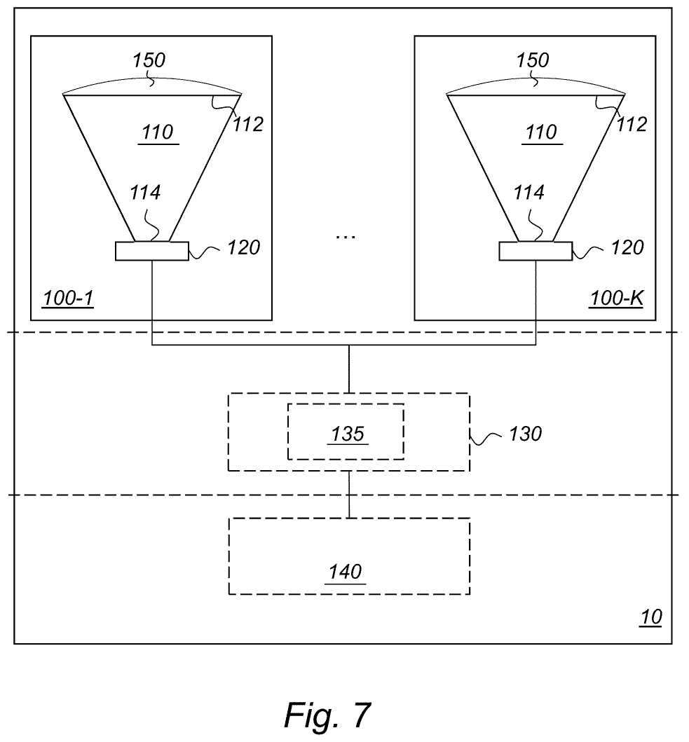

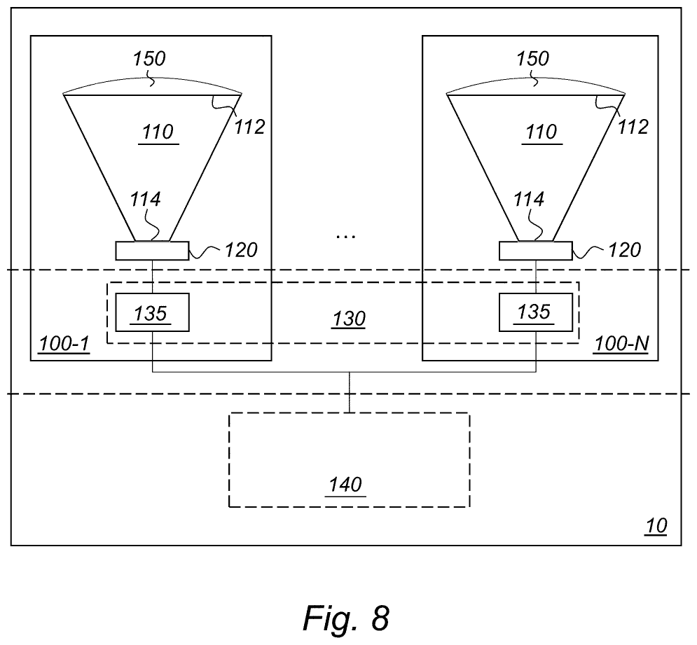

Reference can also be made to FIG. 7 and FIG. 8.

It should be understood that the camera sub-modules 100 are schematically shown side-by-side for simplicity of illustration, but in practice they are spatially arranged such that the input surfaces 112 of the FOTs 110 of the camera sub-modules 100 together define an outward facing overall surface area, which generally corresponds to the surface area of a spheroid or a truncated segment thereof. By way of example, the camera system is built for enabling spherical imaging.

The horizontal dashed lines in FIG. 7 and FIG. 8 illustrate different possible implementations of the camera system, optionally including signal and/or data processing circuitry of various types.

By way of example, the camera system 10 may comprise connections for connecting the sensors 120 of the camera sub-modules 100 to signal and/or data processing circuitry.

In a particular example, the camera system 10 comprises signal processing circuitry 130; 135 configured to process the electrical signals of the sensors 120 of the camera sub-modules 100 to enable formation of an electronic image of at least parts of the surrounding environment.

As an example, the signal processing circuitry 130 may be configured to perform signal filtering, analog-to-digital conversion, signal encoding and/or image processing.

As a complement, the camera system may if desired include a data processing system 140 connected to the signal processing circuitry 130; 135 and configured to generate the electronic image, e.g. see FIGS. 7 and 8. Any suitable data processing system adaptable for processing the data signals from the signal processing circuitry 130; 135 and perform the relevant image processing to generate electronic image and/or video, may be used.

In a particular example, the signal processing circuitry 130 comprises one or more signal processing circuits 135, where a set of camera sub-modules 100-1 to 100-K share a signal processing circuit 135 configured to process the electrical signals of the sensors 120 of the set of camera sub-modules 110-1 to 100-K, e.g. as illustrated in FIG. 7.

In another particular example, the signal processing circuitry 130 comprises a number of signal processing circuits 135, where each camera sub-module 100 comprises an individual signal processing circuit 135 configured to process the electrical signals of the sensor 120 of the camera sub-module 100, e.g. as illustrated in FIG. 8.

The signal and/or data processing may include selecting and/or requesting one or more segments of image data from one or more of the sensors 120 for further processing.

Optionally, each camera sub-module 100 may include an optical element 150 such as an optical lens or an optical lens system arranged on top of the input surface 112 of the FOT 110, e.g. as illustrated in FIGS. 7, 8, 11 and 12.

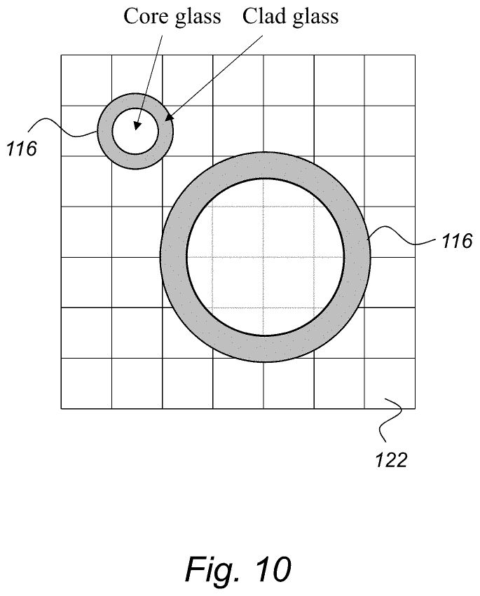

As a possible design choice, the number of pixels per optical fiber may be, e.g. in the range between 1 and 100, e.g. see FIG. 10.

In a particular example, the number of pixels per optical fiber is in the range between 1 and 10.

By way of example, the camera sub-modules may be spatially arranged to enable zero parallax between images from neighboring camera sub-modules.

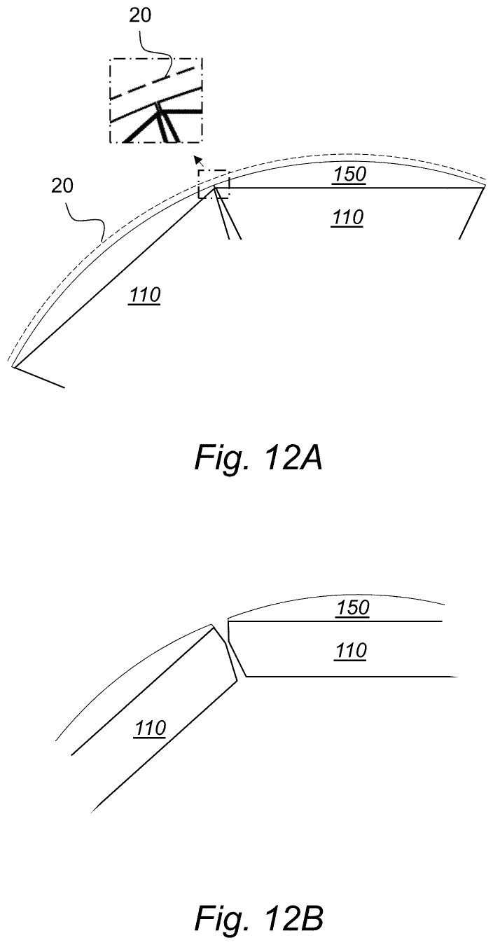

It may be desirable to spatially arrange the camera sub-modules such that the input surfaces of the FOTs of neighboring camera sub-modules are seamlessly adjoined, e.g. as illustrated in FIG. 12.

Alternatively, or as a complement, the electrical signals of the sensors of neighboring sub-camera modules may be processed to correct for parallax errors caused by small displacement between sub-camera modules.

By way of example, the FOTs may be adapted for conveying photons in the infrared, visible and/or ultraviolet part of the electromagnetic spectrum, and the sensor may be adapted for infrared imaging, visible light imaging and/or ultraviolet imaging.

Accordingly, the sensor may for example be a short wave, near wave, mid wave and/or long infrared sensor, a light image sensor and/or an ultraviolet sensor.

For example, the camera system may be a video camera system, a video sensor system, a light field sensor, a volumetric sensor and/or a still image camera system.

The camera system may be adapted, e.g., for immersive and/or spherical 360 degrees video content production for virtual, augmented and/or mixed reality applications.

By way of example, the FOTs of the camera sub-modules 100 may be spatially arranged to form a generally spherical three-dimensional geometric form, or a truncated segment thereof, the size of which is large enough to encompass a so-called Inter-Pupil Distance or Inter-Pupillary Distance (IPD). For example, the diameter of the generally round or spherical geometric form should thus be larger than the IPD. This will enable selection of image data from selected parts of the overall imaging surface area of the camera system that correspond to the IPD of a person to allow for three-dimensional imaging effects.

The proposed technology also covers a camera sub-module for building a modular camera or camera system.

According to another aspect, there is thus provided a camera sub-module 100 for a camera system comprising multiple camera sub-modules, wherein the camera sub-module 100 comprises:
a tapered Fiber Optic Plate, FOP, which in tapered form is referred to as a Fiber Optic Taper, FOT, 110 for conveying photons from an input surface 112 to an output surface 114 of the FOT, each FOT 110 comprising a bundle of optical fibers 116 arranged together to form the FOT;
a sensor 120 for capturing the photons of the output surface 114 of the FOT 110 and converting the photons into electrical signals, wherein the sensor 120 is provided with a plurality of pixels 122, and each optical fiber 116 of the FOT is matched to a set of one or more pixels on the sensor.

For example, reference can once again be made to FIGS. 5 to 10.

By way of example, the camera sub-module 100 may also comprise optional electronic circuitry 130; 135; 140 configured to perform signal and/or data processing of the electrical signals of the sensor, as previously discussed.

In a particular example, the camera sub-module 100 may further comprise an optical element 150 such as an optical lens or an optical lens system arranged on top of the input surface 112 of the FOT 110.

By way of example, the FOT 110 is normally arranged to assume a determined magnification/reduction ratio between input surface 112 and output surface 114.

In the following, the proposed technology will be described with reference a set of non-limiting examples.

As mentioned by way of example, the proposed technology may be used, e.g. for zero optical parallax for immersive 360 cameras. As an example, such a camera or camera system may involve a set of customized fiber optic tapers in conjunction with image sensors and associated electronics arranged as camera sub-modules having facets in an Archimedean solid or other relevant three dimensional geometrical form, for covering a region of interest.

In particular, the proposed technology may provide a solution for parallax free image and video production in immersive 360 camera designs. An advantage is that the need for parallax correction is significantly relaxed or possibly even eliminated for real time live video or post productions captured from the system and consequently a minimum demand of computer power is needed in the image and video process, which results in reduced times in the real time video streaming process and also allows for the design of more compact and mobile camera designs compared with current methods and designs.

By way of example, the proposed technology may involve a set of tailor-designed fiber optic tapers in conjunction with image sensors and associated electronics, realizing new designs and video data processing of immersive and/or 360 video content, data streaming and/or cameras.

In a particular, non-limiting example, the proposed technology is based on a set of FOTs designed and spatially arranged as facets arranged in Archimedean solids or other relevant three dimensional geometrically forms. For example, one form is the truncated icosahedron, see the example of FIG. 6, having 12 pentagonal shaped FOTs and 20 hexagonal shaped FOTs. Each FOT is normally coupled to an individual image sensor. The truncated icosahedron form results in a composition of 32 individual, outward facing sub camera elements covering all or parts of a surrounding environment fulfilling a complete spherical coverage. This method allows for zero parallax, or close to zero parallax, between images from each neighboring individual sub camera element. It should though be understood that due to physical limitations in the manufacturing process of the camera system, slight image correction may still be needed.

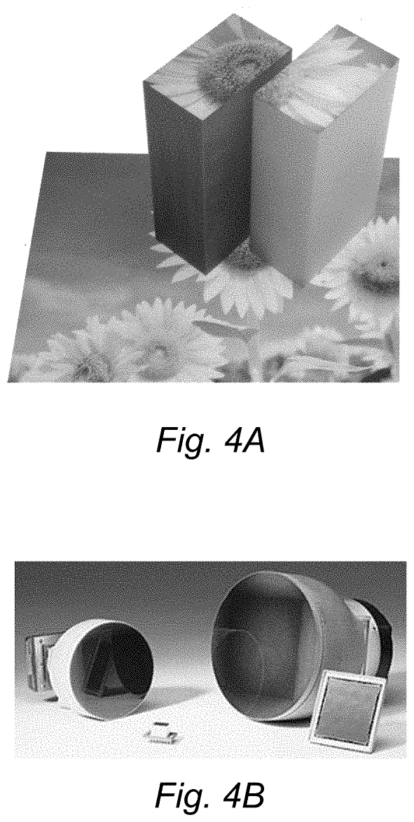

Fiber optic plates (FOP) are optical devices comprised of a bundle of micron-sized optical fibers. Fiber optical plates are generally composed of a large number of optical fibers fused together into a solid 3D geometry coupled to an image sensor such as a CCD or CMOS device. A FOP is geometrically characterized by having the input and output sides equal in size that directly conveys light or image incident on its input surface to its output surface, see FIG. 4A.

A tapered FOP, which is normally referred to as a fiber optic taper (FOT), is typically fabricated by heat treatment to have a different size ratio between their input and output surfaces, see FIG. 4B. A FOT normally magnifies or reduces the input image at a desired ratio. By way of example, the magnification/reduction ratio for a standard FOT is typically 1:2 to 1:5.

By fiber optic plate and/or fiber optic taper in the embodiments herein is normally intended to be an element, device or unit by means of which light and images are conveyed from one side to the other.

FIG. 4A schematically illustrates light conveyed in a FOP from input side to output side transposing the image by the height of the FOP. FIG. 4B shows a circular, manufactured FOT attached to respective sensor element in a commercial solution.

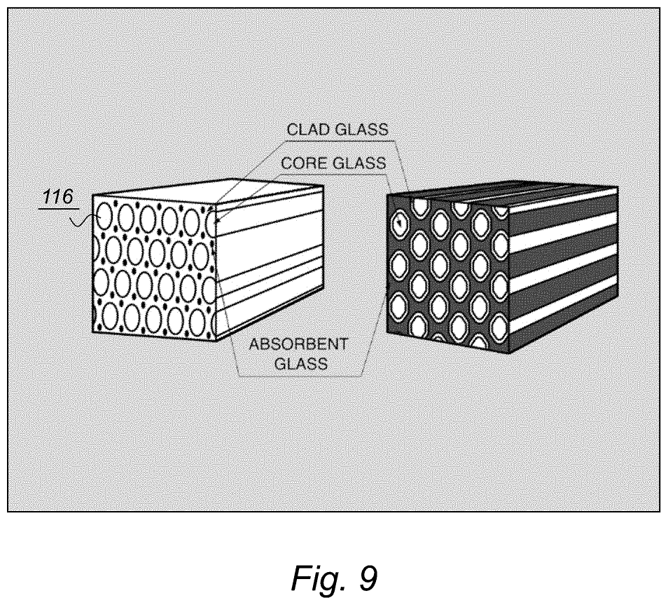

FIG. 9 is a schematic diagram illustrating an example of a FOT comprising bundles of optical fibers, e.g. with ISA (Interstitial Absorption Method) and/or EMA (Extramural Absorption Method) methods applied in the manufacturing process according to an illustrative embodiment.

In the example of FIG. 9, the FOT 110 comprises a core glass, single or multi-mode fiber which most of the light passes, clad glass where light is reflected from the boundary between the clad and core glasses and absorbent glass absorbing stray light not reflected. Depending on absorbent glass implementation, referred to as methods such as ISA, EMA or others, the FOT numerical aperture NA can be set either to 1.0 or less due to difference in glass refractive indices which also determines the angle for the light receiving angle. A smaller fiber pitch value increases the contrast of the FOT due to less cross talk light which escapes the clad glass and into neighboring core glass and consequently detected on neighboring sensor pixel elements.

In order to keep a high contrast of the FOT by parallel input light and a large numerical aperture to ensure as much light as possible to be detected by the sensor, an optical element 150 can be added on top of the input surface 112 of the FOT 110, e.g. as illustrated in FIGS. 6, 7, 11 and 12. The optical element 150 can be designed to allow for an arbitrary range of incident light angle.

FIG. 10 is a schematic diagram illustrating an example of relevant parts of a sensor pixel array with two optical fibers of different sizes interfacing the pixel array; one optical fiber in size covering only one pixel and a larger optical fiber covering many pixels in the array according to an illustrative embodiment.

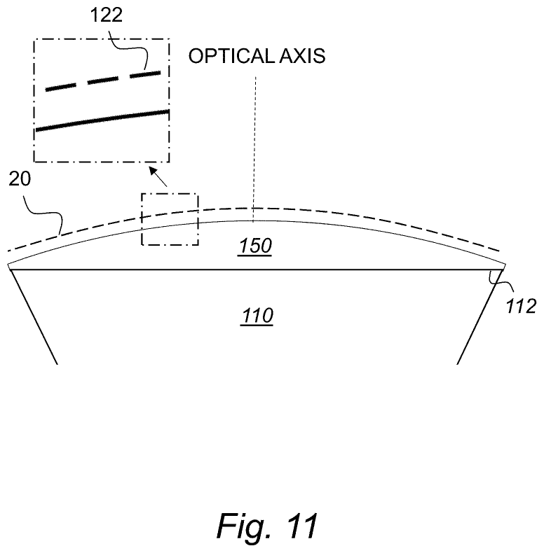

FIG. 11 is a schematic diagram illustrating an example of the outward facing surface pixel area of a camera sub-module according to an illustrative embodiment. The dashed line 20 illustrates the principle of translation of image pixel elements on element 150 by the sub-module comprising the FOT.

The design virtually transposes the sensor pixel array of the sensor to the outer or external surface of element 150 or to surface 112. Herein the term EVPE stands for External Virtual Pixel Element, each of which corresponds to one or more of the pixels 122 of the sensor pixel array.

In a sense, when considering a whole set of camera sub-modules, the outward facing overall surface area can be viewed as an EVPE array or continuum that corresponds to the sensor pixel array defined by the sensors of the camera sub-modules. In other words, the (internal) sensor pixel array of the sensor(s) is virtually transposed to a corresponding (external) array of EVPEs on the outward facing overall surface area, or the other way around.

FIG. 12 is a schematic diagram illustrating an example of how the outward facing surface areas 20 of two camera sub-modules define a joint outward facing surface pixel area covering parts of a surrounding environment according to an illustrative embodiment.

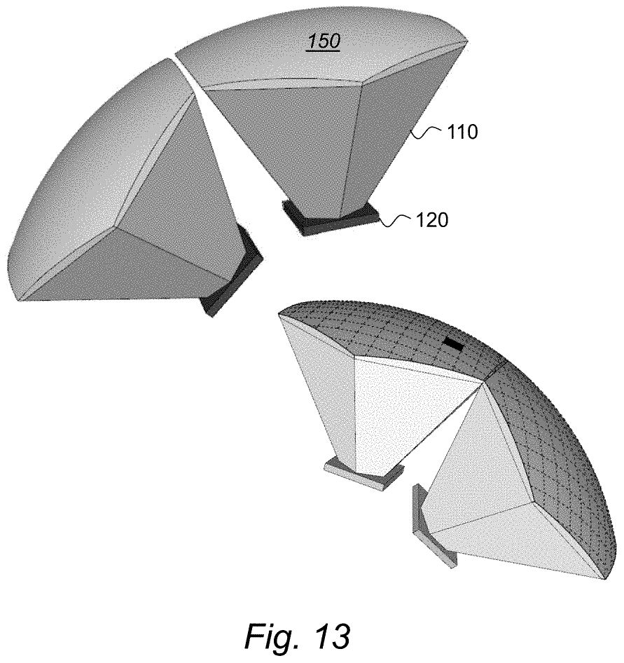

FIG. 13 is a schematic diagram illustrating an example of two hexagonal camera sub-modules define a joint outward facing surface pixel area covering parts of a surrounding environment according to an illustrative embodiment.

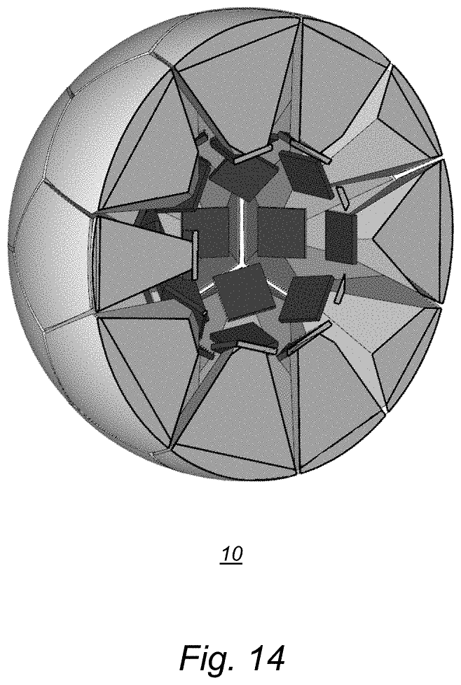

FIG. 14 is a schematic diagram illustrating an example of camera system built as a truncated icosahedron composed of a number of pentagonal and hexagonal shaped sub-modules, cut in half to show also the inner structure of such a camera system arrangement according to an illustrative embodiment.

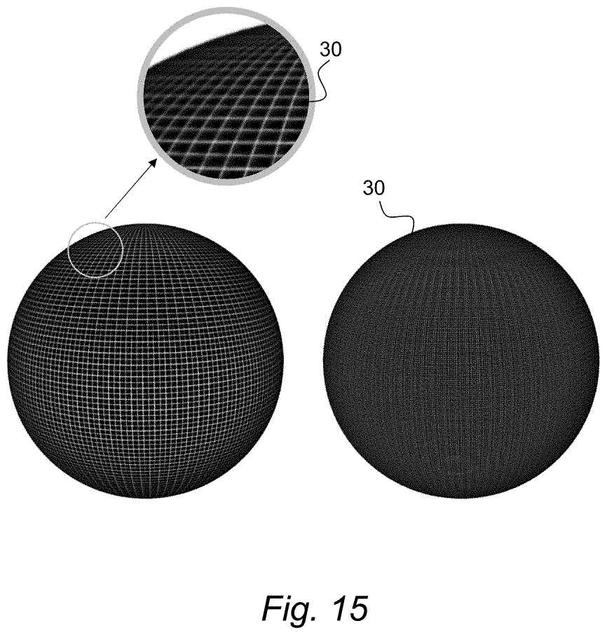

By way of example, hexagonal and pentagonal shaped FOTs 110 of camera sub-modules may be arranged as part of a truncated icosahedron, e.g. see FIG. 8, to create a joint (EVPE) pixel array on the surface area 20 illustrated in FIG. 12 or mapped into surface segments 30 composed of EVPE:s, e.g. as illustrated in FIG. 15. Adjacent surfaces of the optical element 150 or the input surface 112 of neighboring FOTs 110 effectively create a surface EVPE continuum across the complete geometric Archimedean solids or other form, building the complete camera surface element, thus reducing or eliminating parallax between individual camera sub-modules 100.

By way of example, the camera system comprises a data processing system configured to realize spherical 2D (monoscopic) and/or 3D (stereoscopic) image/video output by requesting and/or selecting the image data corresponding to one or more regions of interest of the (parallax-free) outward facing External Virtual Pixel Elements (EVPE:s) as one or more so-called viewports for display.

In other words, the camera system comprises a data processing system configured to request and/or select image data corresponding to one or more regions of interest of the outward facing overall imaging surface area of the camera system for display.

To provide 2D image and/or video output, the data processing system is configured to request and/or select image data corresponding to a region of interest as one and the same viewport for display by a pair of display and/or viewing devices.

To provide 3D image and/or video output, the data processing system is configured to request and/or select image data corresponding to two different regions of interest as two individual viewports for display by a pair of display and/or viewing devices.

For 3D output, the two different regions of interest are normally circular regions, the center points of which are separated by an Inter-Pupil Distance or Inter-Pupillary Distance, IPD. The IPD corresponds to the distance between human eyes, normalized or individualized.

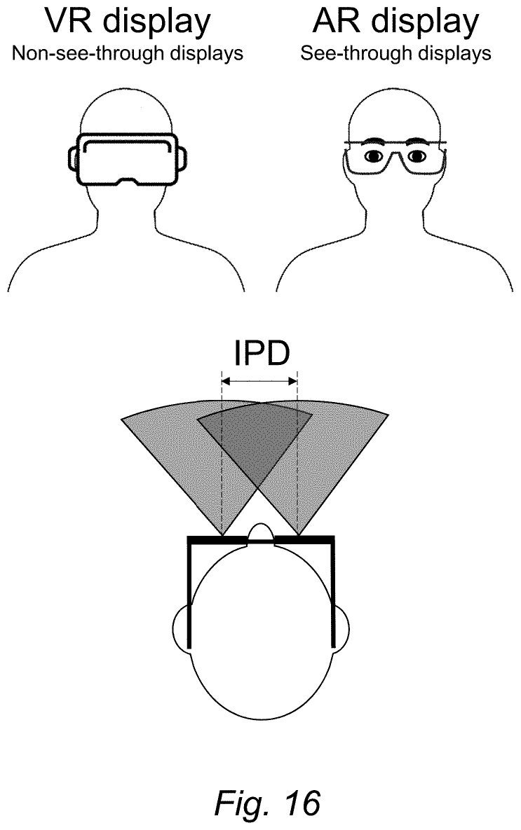

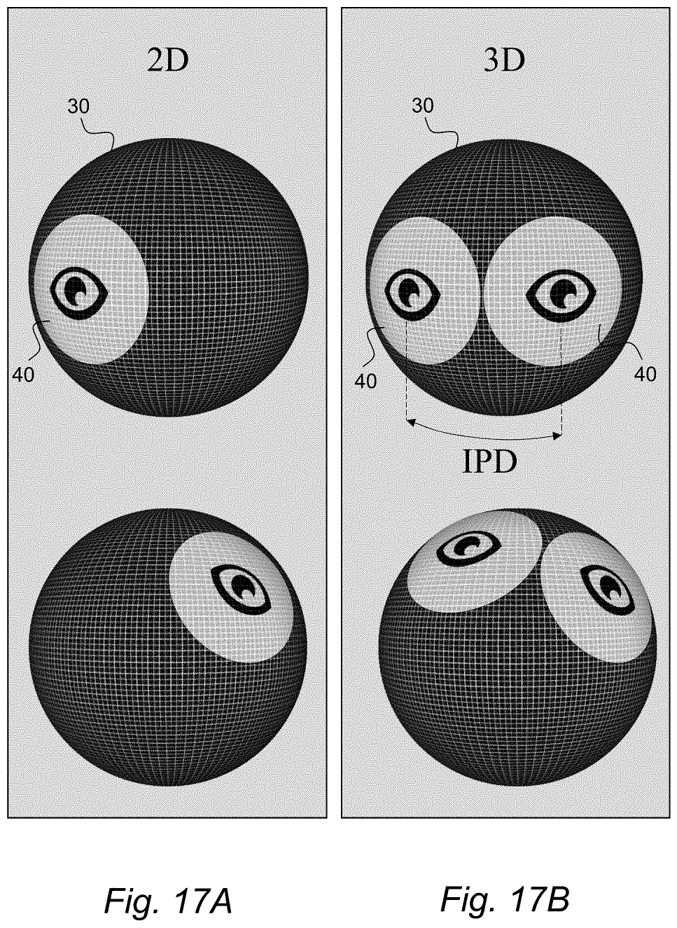

By way of example, reference can be made to FIG. 16 and FIG. 17.

In a particular example, surface segments capturing EVPE image data, corresponding to one or more viewports 40, are selected for display. For example, the viewports 40 are the imagery displayed in a pair of VR and/or AR viewing devices.

A pair of VR and AR viewing devices is typically designed with two image screens and associated optics, one for each eye. A 2D perception of a scene is achieved by displaying the same imagery (viewport) in both displays. A 3D depth perception of a scene is typically achieved by displaying a viewport on each display corresponding to an image viewed from each eye displaced by the IPD. From this parallax, the human brain and its visual cortex creates the 3D depth perception.

The viewport, composed of EVPE:s, is mapped from sets of camera sub-modules 100 and corresponding sensor element 120 and region of interest (ROI) functionality allowing for selectable viewport image readouts. A 2D and/or 3D viewport realization is/are thus realized by using the same viewport for both eyes for 2D monoscopic display and viewports separated by IPD, e.g. as illustrated in FIG. 17A for a monoscopic 2D display, and in FIG. 17B for a stereoscopic 3D display in VR and AR devices.

By way of example, the mapping of EVPE:s can be image processed by computer implementation 200 to allow for tiled and viewport dependent streaming.

In order to get a feeling of the expected complexity of possible camera realizations, reference can be made to the following illustrative and non-limiting examples. By way of example, a typical FOT 110 may be supporting image resolutions ranging, e.g., from 20 Ip/mm to 250 Ip/mm and typically from 100 Ip/mm to 120 Ip/mm, but not limited to these values (Ip stands for line pairs). Typical fiber optic element 116 sizes may range, e.g., from 2.5 μm to 25 μm but not limited to this range. For example, the image resolution of sensor 120 may be ranging, typically, from 1 Mpixel to 30 Mpixel, but not limited to this range. As an example, the camera system 10 may have an angular image resolution, which ranges, typically, from 2 pix/degree to 80 pix/degree but not limited to these values. In this particular example, the number of EVPE:s is thus ranging, typically, from 30 million to 1 billion for a camera system. Based on VR/AR viewing devices with 40 and 100 degrees field of view, the corresponding viewport EVPE density may range, e.g., from 0.6 to 20 Mpixel and 3 to 120 Mpixel respectively.

It will be appreciated that the methods and devices described above can be combined and re-arranged in a variety of ways, and that the methods can be performed by one or more suitably programmed or configured digital signal processors and other known electronic circuits (e.g. Field Programmable Gate Array (FPGA) devices, Graphic Processing Unit (GPU) devices, discrete logic gates interconnected to perform a specialized function, and/or application-specific integrated circuits).

Many aspects of this invention are described in terms of sequences of actions that can be performed by, for example, elements of a programmable computer system. The steps, functions, procedures and/or blocks described above may be implemented in hardware using any conventional technology, such as discrete circuit or integrated circuit technology, including both general-purpose electronic circuitry and application-specific circuitry.

Alternatively, at least some of the steps, functions, procedures and/or blocks described above may be implemented in software for execution by a suitable computer or processing device such as a microprocessor, Digital Signal Processor (DSP) and/or any suitable programmable logic device such as a FPGA device, a GPU device and/or a Programmable Logic Controller (PLC) device.

It should also be understood that it may be possible to re-use the general processing capabilities of any device in which the invention is implemented. It may also be possible to re-use existing software, e.g. by reprogramming of the existing software or by adding new software components.

It is also possible to provide a solution based on a combination of hardware and software. The actual hardware-software partitioning can be decided by a system designer based on a number of factors including processing speed, cost of implementation and other requirements.

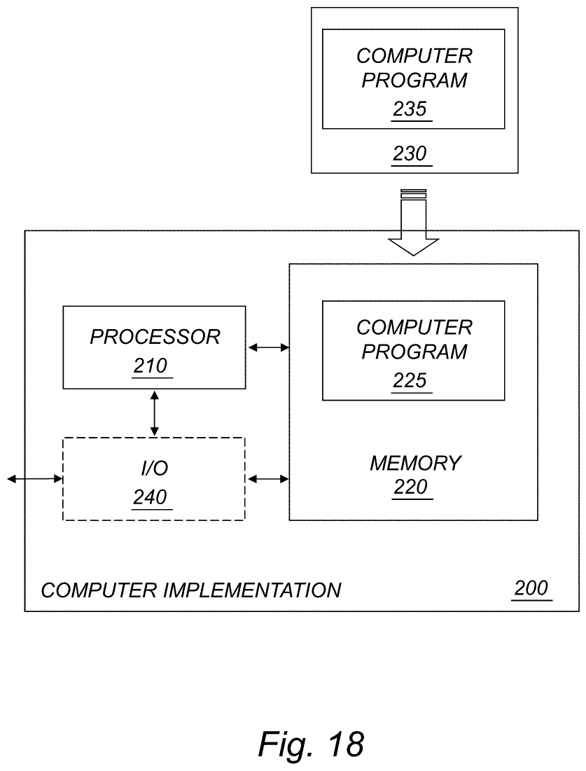

FIG. 18 is a schematic diagram illustrating an example of a computer-implementation 200 according to an embodiment. In this particular example, at least some of the steps, functions, procedures, modules and/or blocks described herein are implemented in a computer program 225; 235, which is loaded into the memory 220 for execution by processing circuitry including one or more processors 210. The processor(s) 210 and memory 220 are interconnected to each other to enable normal software execution. An optional input/output device 240 may also be interconnected to the processor(s) 210 and/or the memory 220 to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors 210 is thus configured to perform, when executing the computer program 225, well-defined processing tasks such as those described herein, including signal processing and/or data processing such as image processing.

The processing circuitry does not have to be dedicated to only execute the above-described steps, functions, procedure and/or blocks, but may also execute other tasks.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions.

The software may be realized as a computer program product, which is normally carried on a non-transitory computer-readable medium, for example a CD, DVD, USB memory, hard drive or any other conventional memory device. The software may thus be loaded into the operating memory of a computer or equivalent processing system for execution by a processor. The computer/processor does not have to be dedicated to only execute the above-described steps, functions, procedure and/or blocks, but may also execute other software tasks.

The flow diagram or diagrams presented herein may be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor.

The computer program residing in memory may thus be organized as appropriate function modules configured to perform, when executed by the processor, at least part of the steps and/or tasks described herein.

Alternatively, it is possible to realize the module(s) predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or Application Specific Integrated Circuits (ASICs) as previously mentioned. Other examples of usable hardware include input/output (I/O) circuitry and/or circuitry for receiving and/or sending signals. The extent of software versus hardware is purely implementation selection.

It is becoming increasingly popular to provide computing services (hardware and/or software) where the resources are delivered as a service to remote locations over a network. By way of example, this means that functionality, as described herein, can be distributed or re-located to one or more separate physical nodes or servers. The functionality may be re-located or distributed to one or more jointly acting physical and/or virtual machines that can be positioned in separate physical node(s), i.e. in the so-called cloud. This is sometimes also referred to as cloud computing, edge computing or fog computing, which is a model for enabling ubiquitous on-demand network access to a pool of configurable computing resources such as networks, servers, storage, applications and general or customized services.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1.-32. (canceled)

33. A camera system comprising multiple camera sub-modules, wherein each camera sub-module comprises:
a tapered Fiber Optic Plate, FOP, which in tapered form is referred to as a Fiber Optic Taper, FOT, for conveying photons from an input surface to an output surface of the FOT, each FOT comprising a bundle of optical fibers arranged together to form the FOT, wherein the FOT is adapted for conveying photons in the infrared part of the electromagnetic spectrum;
a sensor for capturing the photons of the output surface of the FOT and converting the photons into electrical signals, wherein the sensor is a short wave, near wave, mid wave and/or long infrared sensor adapted for infrared imaging and the sensor is provided with a plurality of pixels, and each optical fiber of the FOT is matched to a set of multiple pixels on the sensor,
wherein the camera sub-modules are spatially arranged such that the input surfaces of the FOTs of the camera sub-modules together define an outward facing overall surface area, which generally corresponds to the surface area of a spheroid or a truncated segment thereof, for covering at least parts of a surrounding environment,
wherein the sensor pixel array defined by the sensors of the camera sub-modules is virtually transposed to a corresponding external array of External Virtual Pixel Elements, EVPEs, on the outward facing overall surface area, and each optical fiber covers many pixels of the sensor pixel array.

34. The camera system of claim 33, wherein the camera sub-modules are spatially arranged such that the input surfaces of the FOTs of the camera sub-modules together define an outward facing overall surface area, which generally corresponds to the surface area of a sphere or a truncated segment thereof to provide at least partially spherical coverage of the surrounding environment.

35. The camera system of claim 33, wherein the camera sub-modules are spatially arranged such that the input surfaces of the FOTs of the camera sub-modules together define an outward facing overall surface area with half-spherical to full-spherical coverage of the surrounding environment.

36. The camera system of claim 33, wherein the camera sub-modules are spatially arranged such that the output surfaces of the FOTs of the camera sub-modules are directed inwards towards a central part of the camera system, and the sensors are located in the central part of the camera system.

37. The camera system of claim 33, wherein the FOTs of the camera sub-modules are spatially arranged to form a generally spherical three-dimensional geometric form or a truncated segment thereof having an outward facing overall surface area corresponding to the input surfaces of the FOTs.

38. The camera system of claim 33, wherein the FOTs of the camera sub-modules are spatially arranged to form an at least partly symmetric, semi-regular convex polyhedron composed of two or more types of regular polygons, or a truncated segment thereof.

39. The camera system of claim 33, wherein the FOTs of the camera sub-modules are spatially arranged to form a three-dimensional Archimedean solid or a dual or complementary form of an Archimedean solid, or a truncated segment thereof, and the input surfaces of the FOTs correspond to the facets of the Archimedean solid or of the dual or complementary form of the Archimedean solid, or of a truncated segment thereof.

40. The camera system of claim 33, wherein the FOTs of the camera sub-modules are spatially arranged to form any of the following three-dimensional geometric forms, or a truncated segment thereof: cuboctahedron, great rhombicosidodecahedron, great rhombicuboctahedron, icosidodecahedron, small rhombicosidodecahedron, small rhombicuboctahedron, snub cube, snub dodecahedron, truncated cube, truncated dodecahedron, truncated icosahedron, truncated octahedron, and truncated tetrahedron, deltoidal hexecontahedron, deltoidal icositetrahedron, disdyakis dodechedron, disdyakis tracontahedron, pentagonal hexecontahedron, pentagonal icositetrahedron, pentakis dodecahedron, rhombic dodecahedron, rhombic tracontahedron, small triakis octahedron, tetrakis hexahedron, triakis icosahedron.

41. The camera system of claim 33, wherein the camera system comprises connections for connecting the sensors of the camera sub-modules to signal and/or data processing circuitry, and the camera system comprises signal processing circuitry configured to process the electrical signals of the sensors of the camera sub-modules to enable formation of an electronic image of at least parts of the surrounding environment.

42. The camera system of claim 41, wherein the signal processing circuitry is configured to perform signal filtering, analog-to-digital conversion, signal encoding and/or image processing, and/or the camera system comprises a data processing system connected to the signal processing circuitry and configured to generate the electronic image.

43. The camera system of claim 41, wherein the signal processing circuitry comprises one or more signal processing circuits, and a set of camera sub-modules share a signal processing circuit configured to process the electrical signals of the sensors of the set of camera sub-modules.

44. The camera system of claim 41, wherein the signal processing circuitry comprises a number of signal processing circuits, and each camera sub-module comprises an individual signal processing circuit configured to process the electrical signals of the sensor of the camera sub-module.

45. The camera system of claim 33, wherein each camera sub-module comprises an optical element arranged on top of the input surface of the FOT.

46. The camera system of claim 33, wherein the camera sub-modules are spatially arranged such that the input surfaces of the FOTs of neighboring camera sub-modules are seamlessly adjoined, and/or the electrical signals of the sensors of neighboring sub-camera modules are processed to correct for parallax errors.

47. The camera system of claim 33, wherein the camera system is a video camera system, light field camera system, a volumetric sensor system, a video sensor system and/or a still image camera system.

48. The camera system of claim 33, wherein the camera system is a camera system adapted for immersive and/or spherical 360 degrees video content production for virtual, augmented and/or mixed reality applications.

49. The camera system of claim 33, wherein the FOTs of the camera sub-modules are spatially arranged to form a generally spherical three-dimensional geometric form, or a truncated segment thereof, the size of which is large enough to encompass a so-called Inter-Pupil Distance or Inter-Pupillary Distance, IPD.

50. The camera system of claim 33, wherein the camera system comprises a data processing system configured to request and/or select image data corresponding to one or more regions of interest of the outward facing overall imaging surface area of the camera system for display.

51. The camera system of claim 50, wherein the data processing system is configured to request and/or select image data corresponding to a region of interest as one and the same viewport for display by a pair of display and/or viewing devices, to thereby provide 2D image and/or video output.

52. The camera system of claim 50, wherein the data processing system is configured to request and/or select image data corresponding to two different regions of interest as two individual viewports for display by a pair of display and/or viewing devices, to thereby provide 3D image and/or video output, and the two different regions of interest are circular regions, the center points of which are separated by an Inter-Pupil Distance or Inter-Pupillary Distance, IPD.
